(19) United States
(12) Patent Application Publication
(10) Pub. No.: US 2018/0052517 A1
(43) Pub. Date: Feb. 22, 2018

(54) SYSTEM AND METHOD FOR COMMUNICATING INPUTS AND OUTPUTS VIA A WEARABLE APPARATUS

(71) Applicants: Andrea Bulgarelli, Torino (IT); Andrea Baldereschi, Gassino Torinese (IT)

(72) Inventors: Andrea Bulgarelli, Torino (IT); Andrea Baldereschi, Gassino Torinese (IT)

(21) Appl. No.: 15/596,995

(22) Filed: May 16, 2017

Related U.S. Application Data
(60) Provisional application No. 62/337,149, filed on May 16, 2016.

(51) Int. Cl. G06F 3/01; A63F 13/211; A63F 13/25

(52) U.S. Cl. CPC G06F 3/014; G06F 3/017; G06F 3/0346; A63F 13/25; A63F 13/211

(57) ABSTRACT

A system is disclosed comprising one or more of a wearable controller, a wearable apparatus such as a “smart” glove, a mobile device or mobile computer, and operating software, preferably in wireless communication with each other. In one embodiment, these components allow a user to create inputs through their gestures, movements and contacts with other surfaces, which facilitates the ability of the user to perform, edit, remix and produce musical compositions, or enhance a virtual/augmented reality or gaming environment, for example.

### CROSS REFERENCE TO RELATED APPLICATIONS

This application claims priority to U.S. Provisional Patent Application No. 62/337,149, filed on May 16, 2016, which is incorporated herein by reference in its entirety.

### BACKGROUND

Music players, video-gamers, artists and general users that interact with Digital/Virtual/Augmented/Mixed Reality content typically use different type of controllers while editing, composing, designing, playing or creating contents. Many of these controllers are large, non-portable and limited by the mechanical nature of the inputs provided therewith. For example, controllers may include buttons, knobs, sliders, switches, potentiometers, keyboards, mouses or other inputs that assume different specific function according to the nature of the contents that the user interacts with: video-games, music composition and design are some among the most-common examples. As existing controllers suffer multiple problems, including lack of portability and structural ergonomic limitations due to a shape that differs from the human hand, there is a need for a solution, which is addressed in the following disclosure.

### SUMMARY

In one embodiment, the invention comprises a wearable apparatus, such as a smart glove, and a wireless connectable wristband, which allow a user to use his or her hand as an input device. In a preferred embodiment, object of the present invention are accomplished by associating one or more sensors with the user's fingertips, thumb, palm, and/or hand and relaying the corresponding motions of the user to a wearable controller, and potentially one or more electronic, computer or computational devices. In this manner, a user may control, edit, create and generally interact with, by way of example, pre-existing or new Digital/Virtual/Augmented/Mixed Reality contents.

In one embodiment, a “smart” glove is comprised of a number of discrete sensors and worn on a user's hand, and a controller is worn around the user's wrist. In one embodiment the controller may be connected to the smart glove. In another embodiment, the controller is worn as a wristband, and may or may not be coupled to the smart glove. In yet another embodiment, the controller is in communication with the smart glove.

In yet another embodiment, the smart glove is comprised of a piezoresistive material, which may further comprise one or more patterns of conductive fabric embedded therein. In yet another embodiment, the smart glove is comprised of a piezoresistive fabric having one or more electrodes.

In yet another embodiment, the smart glove is comprised of a discrete number of IMU (Inertial Measurement Unit), which may further comprise one or more patterns of conductive fabric embedded therein. In yet another embodiment, the smart glove is comprised of a discrete number of electro-active polymers, which may further comprise one or more patterns of conductive fabric embedded therein.

In yet another embodiment, the smart glove is comprised of a pattern of SMA (Shape-Memory-Alloy), which may further comprise one or more patterns of conductive fabric embedded therein.

Variations, combinations and sub-combinations of these embodiments and others described herein are contemplated for purposes of the present disclosure.

In a preferred embodiment, the invention further comprises a mobile device or mobile computer in communication with the smart glove and/or wearable controller. In an alternate embodiment, the computing device is a desktop style computer. The mobile device or mobile computer preferably is used in conjunction with one or more software applications, and is capable of interfacing with known programs for use in musical recording and sound editing, including Ableton, Traktor, Logic Pro X, Resolume, FL Studio, Pace Maker, iMachine, GarageBand, ProTools, Thumbjam, and Animoog, by way of example but not limitation. Interface may also be achieved with video-gaming or similar platforms like those provided by Sony, Microsoft and Nintendo, by way of example but not limitation. Further, the embodiments described herein may interface with existing Virtual Reality/Augmented Reality/Mixed Reality platforms like the ones from HTC (Vive), Oculus (Rift), Microsoft (HoloLens) and Samsung (Gear VR), by way of example but not limitation.

According to embodiments described herein, the mobile device or mobile computer preferably is used in conjunction with one or more software applications. In one embodiment, the software permits a user to personalize one or more discrete sensors or gesture control movements, enable or disable one or more sensors or gesture control movements, impart pressure/bending sensitivity levels for any one or more sensors or gesture control movements, or create custom combinations for one or more sensors or gesture control movements, as described in further detail below.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The term “electronic device” “mobile device” or “mobile computer” as used herein refers to any hardware device and/or software operable to engage in a computing session. For example, a mobile device can be an IP-enabled computer, a tablet computer, a cellular phone, a personal digital assistant, or a laptop computer system, for example.

The term “network” as used herein refers to a system used by a communication platform to provide communications between mobile computers. The network can consist of one or more session managers, feature servers, mobile computers, etc. that allow communications, whether voice or data, between two users. Generally, a network can be a local area network (LAN), a wide area network (WAN), a wireless LAN, a wireless WAN, the Internet, etc. that receives and transmits messages or data between devices to facilitate communication platform activities. A network may communicate in any format or protocol known in the art, such as, transmission control protocol/internet protocol (TCP/IP), 3202.11g, 3202.11n, Bluetooth, or other formats or protocols.

The term “database,” “archive,” or “data structure” as used herein refers to any system, hardware, software, memory, storage device, firmware, component, etc., that stores data. The data model can be any type of database or storage framework stored on any type of non-transitory, tangible computer readable medium. A database can include one or more data structures, which may comprise one or more sections or portions that store an item of data. A section may include, depending on the type of data structure, an attribute of an object, a data field, or other types of sections included in one or more types of data structures. The data structure can represent a text string or be a component of any type of database, for example, relational databases, flat file databases, object-oriented databases, or other types of databases. Further, the data structures can be stored in memory or memory structures that may be used in either run-time applications or in initializing a communication.

The phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation or technique.

The term “module” refers to any known or later developed hardware, software, firmware, artificial intelligence, fuzzy logic, or combination of hardware and software that is capable of performing the functionality associated with that element. Also, while the various concepts are described in terms of exemplary embodiments, it should be appreciated that aspects can be separately claimed.

Hereinafter, “in communication” shall mean any electrical connection, whether wireless or wired, that allows two or more systems, components, modules, devices, etc. to exchange data, signals, or other information using any protocol or format.

The preceding is a simplified summary to provide an understanding of some aspects of the embodiments. This summary is neither an extensive nor exhaustive overview of the various embodiments. It is intended neither to identify key or critical elements nor to delineate the scope of the embodiments but to present selected concepts in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The accompanying drawings, which are incorporated herein and constitute a part of the specification, illustrate embodiments of the disclosure and serve to explain the principles of these embodiments. In certain instances, details that are not necessary for an understanding of the disclosure or that render other details difficult to perceive may have been omitted. It should be understood, of course, that the present disclosure is not necessarily limited to the particular embodiments illustrated herein. Additionally, it should be understood that the drawings are not necessarily to scale. In the drawings:

FIGS. 1A-1C illustrate the present invention according to one embodiment;

FIGS. 2A-2D illustrate the device shown in FIG. 1A;

FIGS. 3A-3B illustrate the device shown in FIG. 1B;

FIGS. 4A-4D illustrate the components of the present invention according to one embodiment;

FIG. 5 illustrates the device shown in FIG. 2C;

FIG. 6 illustrates the devices shown in FIGS. 1A-1B;

FIGS. 7-8 illustrate details of the device shown in FIG. 6;

FIG. 9 illustrates details of the device shown in FIG. 6;

FIG. 10 illustrates further details of the device shown in FIG. 6;

FIG. 11 illustrates further details of the device shown in FIG. 6;

FIG. 12 illustrates further details of the device shown in FIG. 6;

FIG. 13 illustrates further details of the device shown in FIG. 6;

FIG. 14 illustrates further details of the device shown in FIG. 6;

FIG. 15 illustrates further details of the device shown in FIG. 6;

FIG. 16 illustrates further details of the device shown in FIG. 6;

FIG. 17 illustrates further details of the device shown in FIG. 6;

FIG. 18 illustrates further details of the device shown in FIG. 6;

FIG. 19 illustrates further details of the device shown in FIG. 6;

FIG. 20 illustrates details of the device shown in FIG. 6 in relation to a user;

FIG. 21 illustrates an exemplary mobile device shown in FIG. 1C;

FIG. 22 illustrates details of the component shown in FIG. 21;

FIG. 23 illustrates further details of the component shown in FIG. 21;

FIG. 24 illustrates further details of the component shown in FIG. 21; and

FIG. 25 illustrates further details of the component shown in FIG. 21.

### DETAILED DESCRIPTION

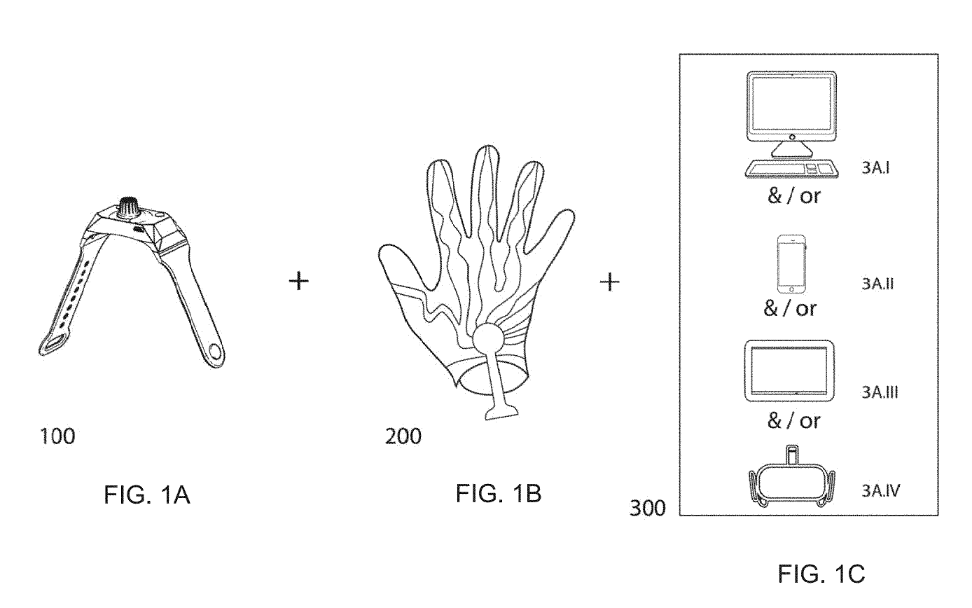

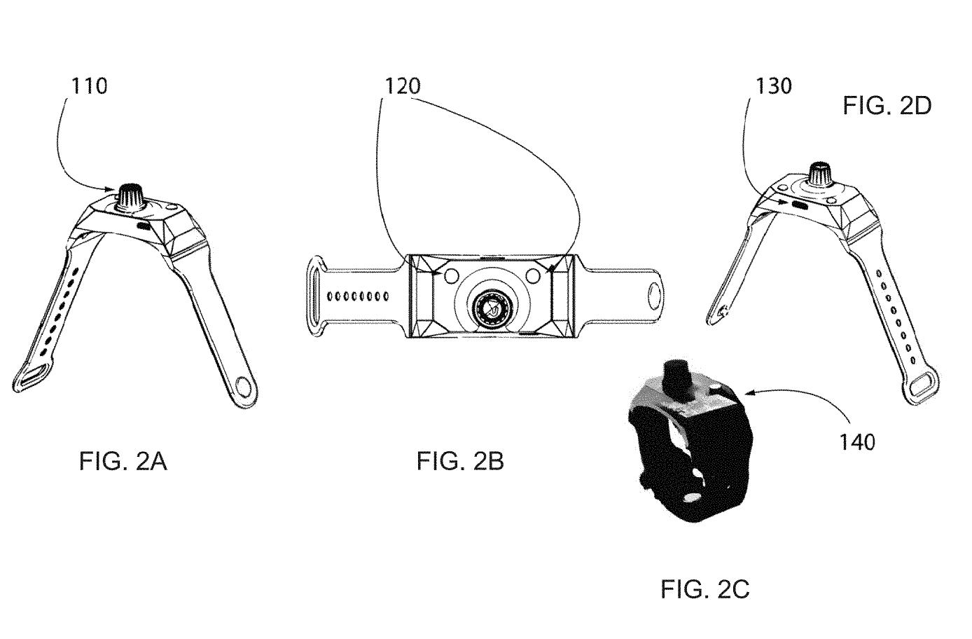

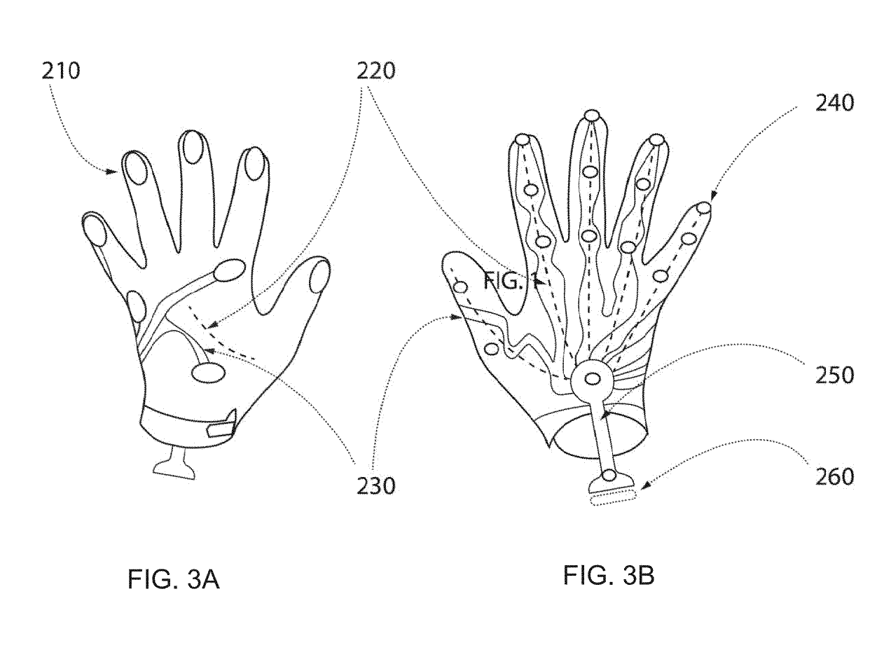

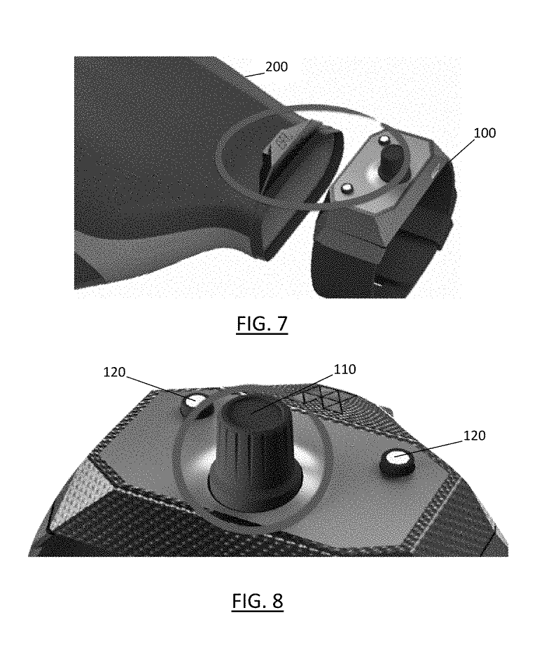

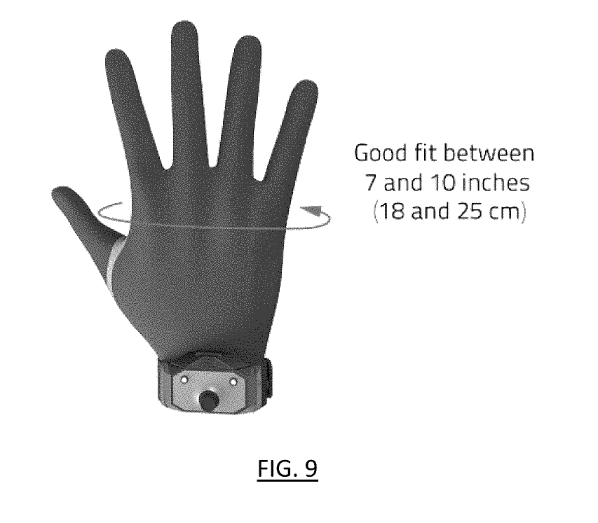

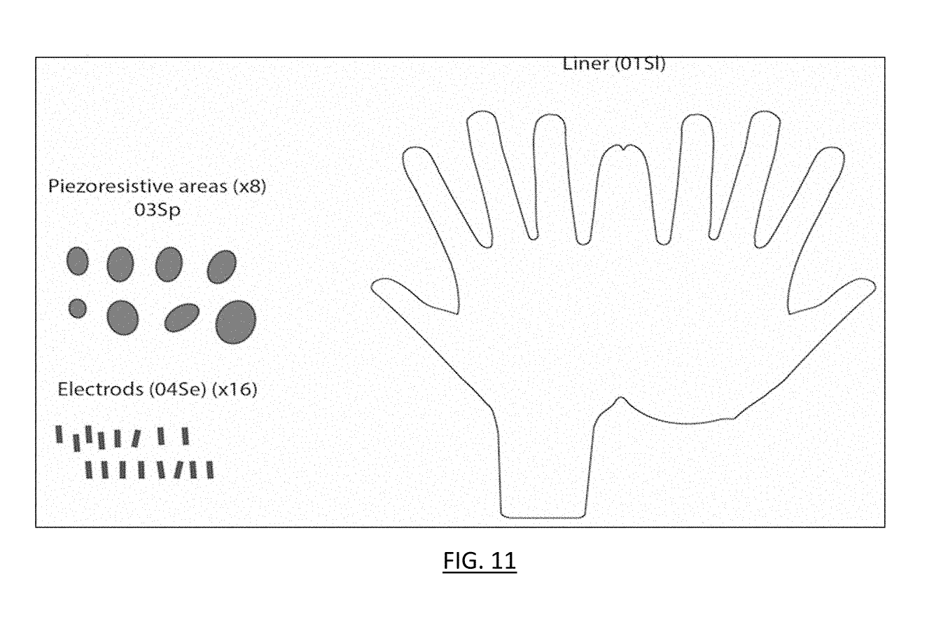

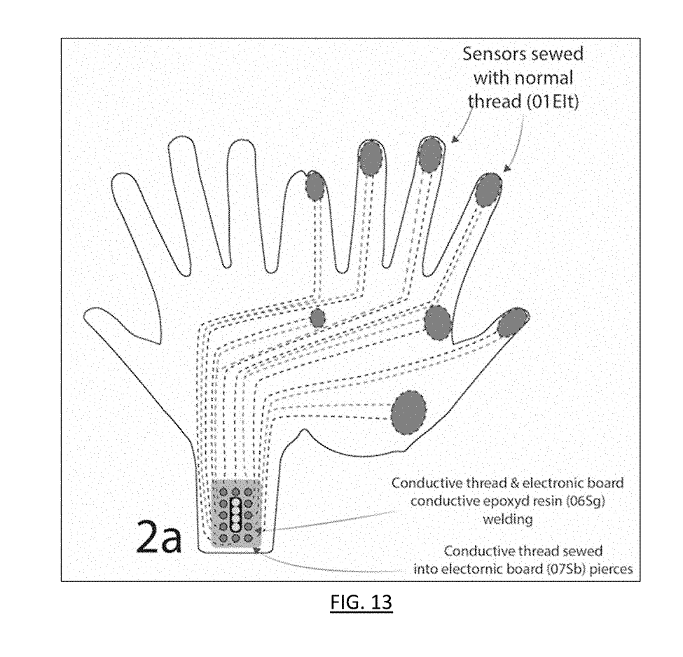

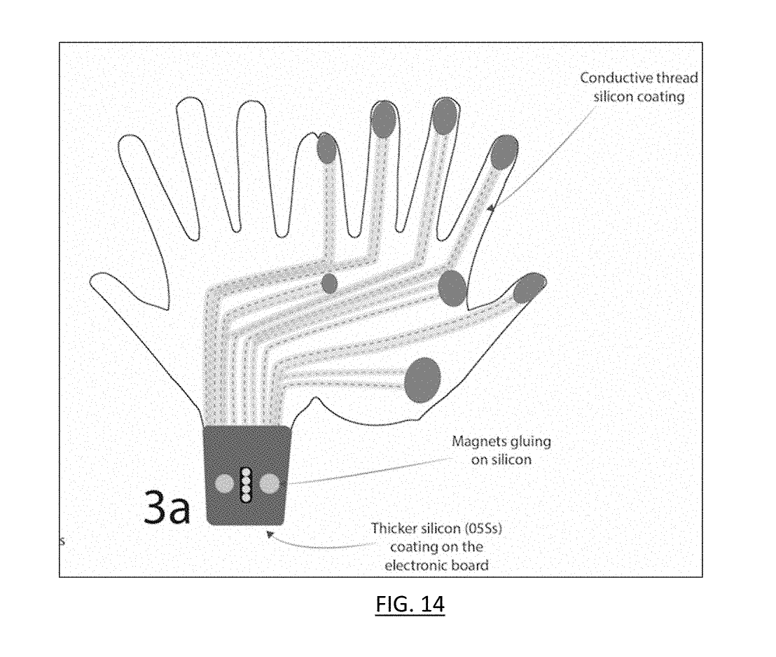

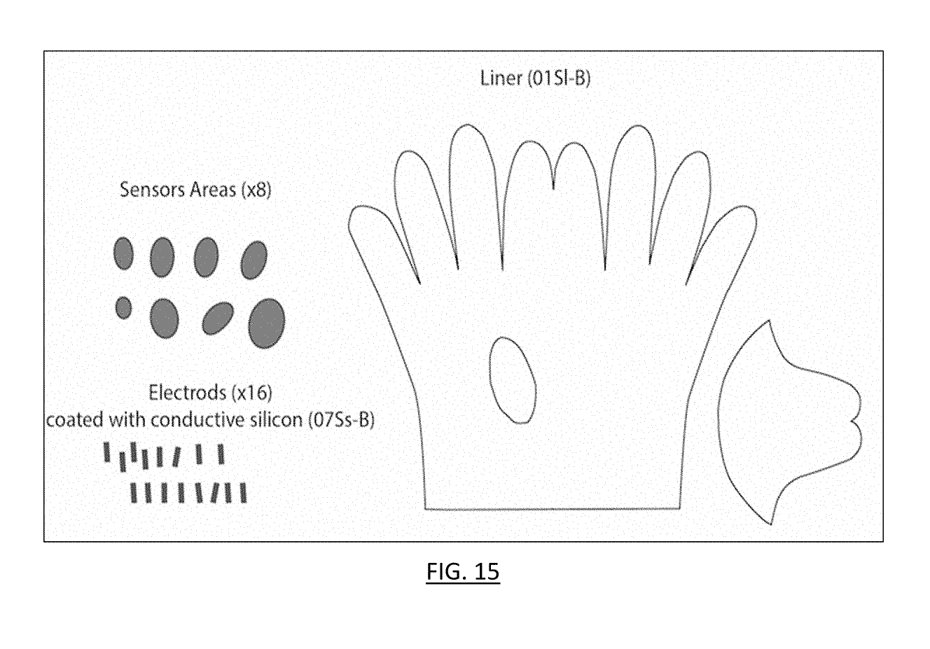

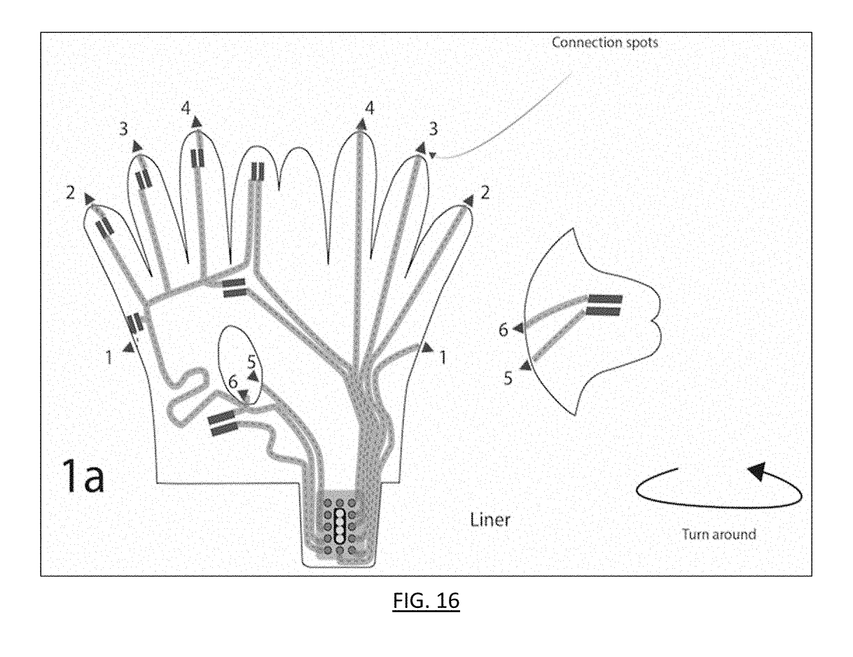

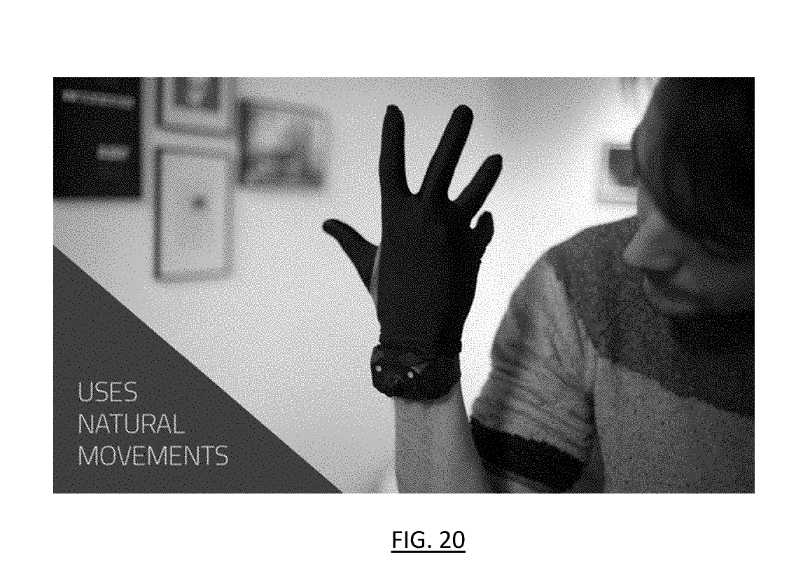

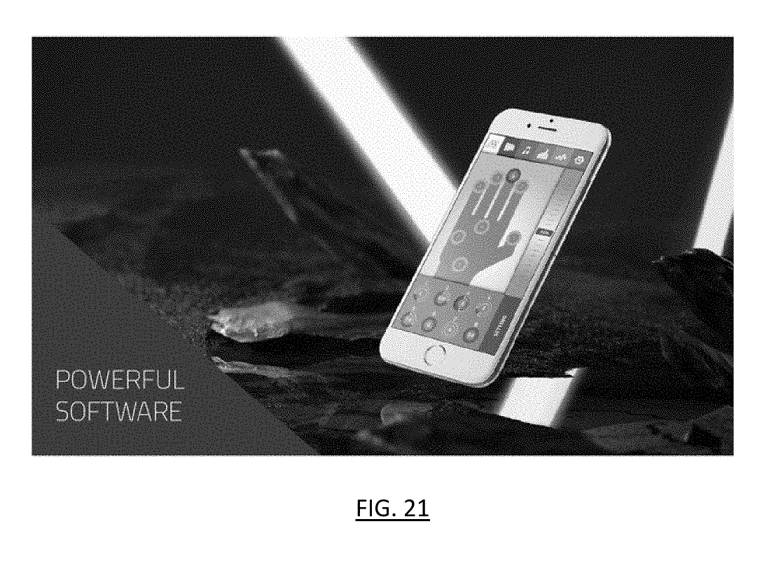

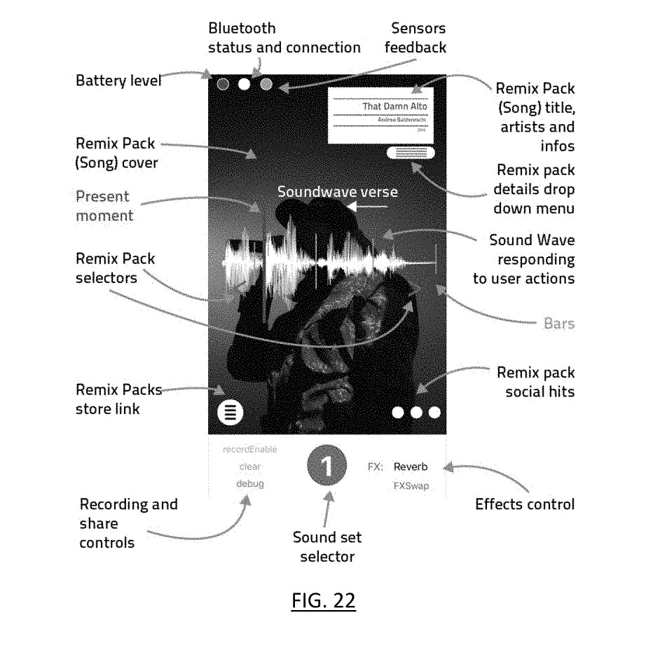

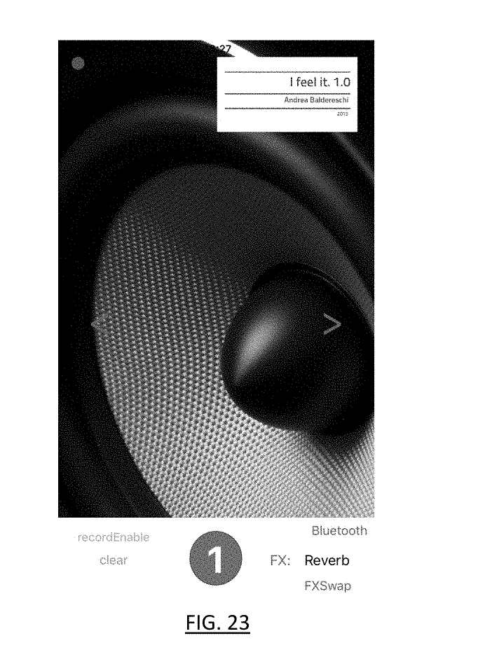

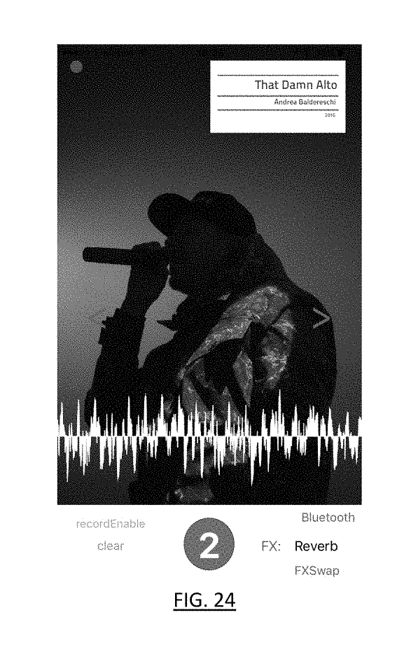

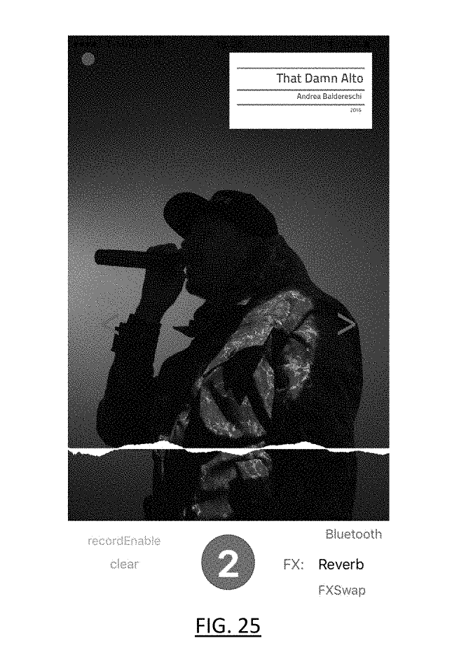

Preferred embodiments of the present disclosure are depicted in FIGS. 1-22. Referring now to FIG. 1, a system according to one embodiment comprises the combination of a wearable controller 100, a wearable apparatus referred to in this embodiment as a smart glove 200, and a mobile device or mobile computer 300 preferably in communication with the wearable controller 100 and/or the smart glove 200. In a preferred embodiment, these components allow a user to interact with devices and communicate inputs/outputs or otherwise access digital content. Further advantages and features of these components are described in greater detail herein.

Referring to FIGS. 1-3, the wearable controller 100 preferably includes an accelerometer and/or gyroscope, or equivalent subcomponents, which registers the movements of the user while wearing the wearable controller 100. By way of example but not limitation, the wearable controller 100 may be programmed to register an upward or downward movement of the user's arm (when wearing the wearable controller 100), the rotation of the user's wrist in a first or a second or more directions, the oscillation of the user's wrist in a first or a second or more directions, or other movements of the user's arm or wrist. Additionally, the wearable controller 100 may discern the speed with which the user makes any corresponding movements, which in turn may impart a different signal or correspond to a different input communicated to the mobile device or mobile computer 300.

The wearable controller may further comprise one or more buttons 120 on a top surface thereof, which in preferred embodiments provide the user with the option to send an I/O signal to the software that can actuate any type of action as a consequence. The buttons 120 may be programmed to impart different outputs when selected in a particular sequence, or simultaneously, for example. The wearable controller 100 may also comprise an encoder 110, or equivalent subcomponent, for switching between different functions. By way of example but not limitation, the encoder 110 may allow a user to switch between different settings or browse through generic items. The wearable controller preferably comprises a connector 130 or equivalent port to plug in or recharge the wearable controller, which may be magnetic, joint or wireless. Variations on this embodiment are contemplated in the present disclosure. The wearable controller preferably comprises a printed circuit board (“PCB”) 140, or equivalent, which is connected to the subcomponents of the wearable controller 100 and to each of the sensors incorporated with the smart glove 200, as described in greater detail below.

The wearable controller preferably is in the form of a wristband, which comprises varying manners of attachment to accommodate different size wrists, such as is used with a wristwatch or similar wearable device. In certain embodiments, the wearable controller 100 may further comprise a micro USB or similar connection for connecting with a mobile device or mobile computer 300, or alternatively for charging or recharging a battery associated with the wearable controller 100. Furthermore, in certain embodiments the wearable controller 100 may comprise one or more LEDs or other display(s), which illuminate or otherwise convey a signal to the user when certain conditions are met or certain inputs are received, and which otherwise alert the user of feedback relating to the wearable controller. It is contemplated that LEDs will be provided with the ability to display multiple different colors of light, each color corresponding to a different event or condition.

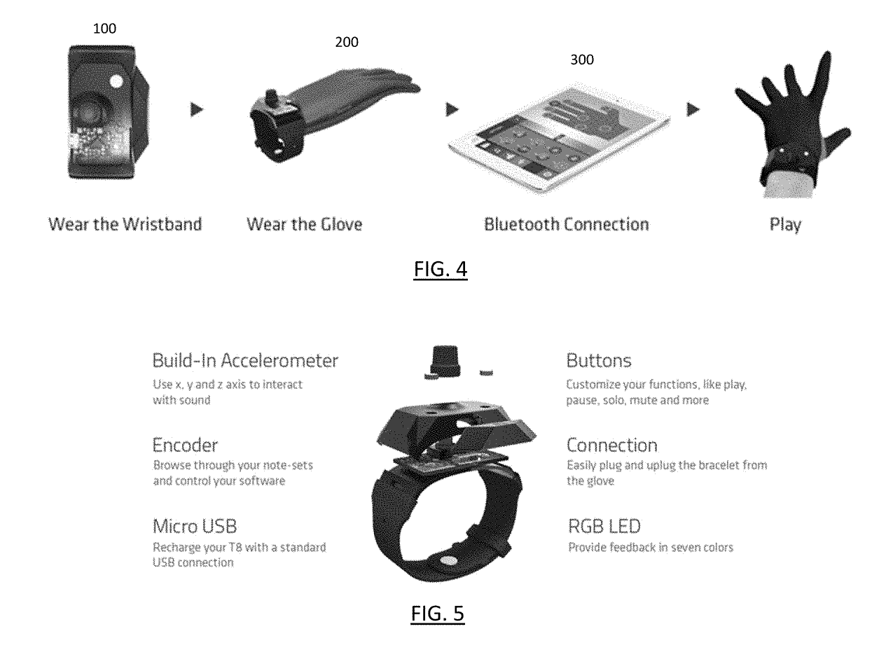

In a preferred embodiment, and with reference to FIG. 4 in particular, the wearable controller 100 may be quickly and easily attached and detached to a wearable apparatus, such as the smart glove 200 described above. In one embodiment, the smart glove 200 is attached to the wearable controller 100 magnetically. According to this embodiment, a spring-pin magnetic connector is used to connect the smart glove 200 to the wearable controller 100. In other embodiments, the smart glove 200 and wearable controller 100 are mechanically attached, such as by a latching mechanism, which secures the smart glove 200 to the wearable controller 100. In a preferred embodiment, the smart glove 200 and wearable controller 100 are in communication with each other, and work in tandem to analyze and translate signals/inputs received from the glove 200 and the wearable controller 100 and communicate to the mobile device or mobile computer 300.

In one embodiment, the wearable controller 100 further comprises an Inertial Measurement Unit (“IMU”) to detect motion, a microcontroller, and/or a BLE (Bluetooth Low Energy) module for communication with the other components of the system, and a rechargeable lithium battery for power. In another embodiment, the wearable controller 100 further comprises a vibrator, oscillator or equivalent, which vibrates or otherwise causes pulses against the user's skin when certain conditions are met or certain inputs are received, and which alert the user of feedback relating to the wearable controller. In yet another embodiment, the wearable controller 100 may be configured to include one or more Haptics, which are activated/deactivated when certain conditions are met or certain inputs are received, and which alert the user of feedback relating to the wearable controller. In yet another embodiment, the wearable controller 100 further comprises a Display which show certain messages (by way of example but not limitation, a series of numbers, words, commands, lists of items, status, etc.) when certain conditions are met or certain inputs are received, and which serve to alert the user of feedback relating to the wearable controller. In yet another embodiment, the wearable controller 100 further comprises a HeartBeat sensor which activate/deactivate when certain conditions are met, and which serve to alert the user of feedback relating to the wearable controller. In yet another embodiment, the wearable controller 100 further comprises a EMG (Electromyography) sensor, which activate/deactivate when certain conditions are met, and which serve to alert the user of feedback relating to the wearable controller and reads data from the skin of the user to use them as input data for the contents the user interact with. Variations on this embodiment are contemplated in the present disclosure.

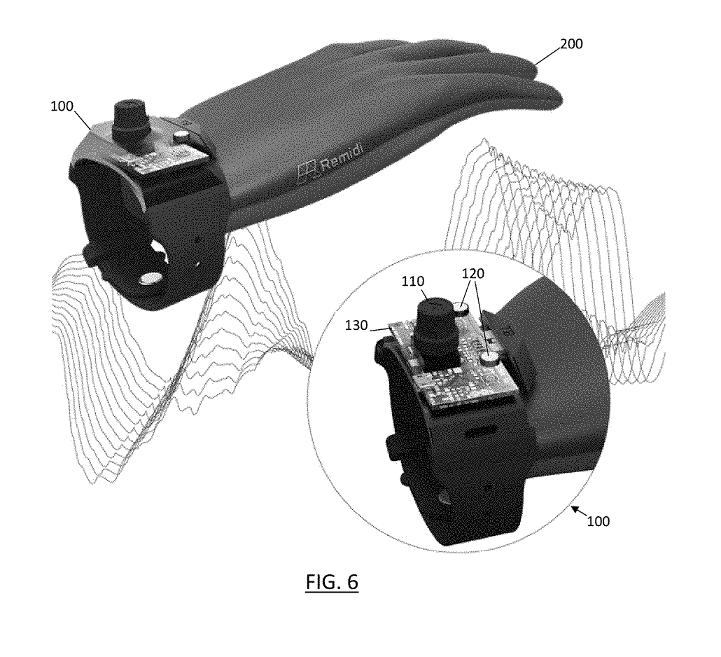

According to certain embodiments, and referring particularly to FIGS. 6-17, the invention according to one embodiment comprises a smart glove 200, which may vary in size but is generally wearable by a variety of different users, and which further comprises one or more discrete sensors, including but not necessarily limited to the following: pressure sensors 210, bending sensors 220 and motion sensors (IMU) 230. In a preferred embodiment, the smart glove 200 comprises no fewer than eight (8) discrete pressure sensors 210, no fewer than six (6) bending sensors 220, no fewer than fifteen (15) motion sensors 240. Out of the eight (8) pressure sensors 210 three sensors are located in the palm of the smart glove 200 and one sensor located in the vicinity of each fingertip. Out of the six (6) bending sensors one is located on the palm and 5 are located on the back of the hand, one on each finger.

According to this embodiment, the sensors (210 and 220) are preferably pressure/bending sensitive sensors, which are capable of receiving inputs and sending outputs to the wearable controller 100 or to one or more mobile devices or mobile computers. The sensors preferably sense the combination of sensors depressed/bended, the duration each sensor is pressed/bended, the degree of pressure each sensor is pressed or depressed, which in turn imparts a different signal/input to the wearable controller 100. In other embodiments, the sensors can not only receive pressure/bending inputs from the user, but are also configured to communicate outputs to the user which are received from the mobile device or computer 300 or otherwise intended to inform the user of a condition or event.

The motion sensors (240) are preferably IMU (Inertial Measurement Units), which are capable of receiving inputs and sending outputs to the wearable controller 100 or to one or more mobile devices or mobile computers 300. The sensors preferably sense discrete movement or motion for different points of the user's hand, or the position of a part of the hand relative to another part of the hand, or the duration each part of the hand is moved, or the speed of movement each sensor is pressed or depressed, or the position relative to the Earth, or a combination of the foregoing, which in turn impart a different signal/input to the wearable controller 100. In one embodiment, the sensors are capable of communicating wirelessly with one or more mobile devices or mobile computers 300.

In one embodiment, the smart glove 200 is comprised of one or more conductive fabrics 230, one magnetic, joint or wireless connector 260 and may further comprise a flexible PCB 250 that acquires data from the one or more sensors and communicates that data from the smart glove 200 to either the wearable controller 100 or the mobile device or mobile computer 300. In another embodiment, the smart glove 200 is comprised of three different layers: one inner layer, which is direct contact with the user's hand; one middle layer, with sensors and flexible PCB, as applicable; and an outer layer, which is preferably a flexible material such as spandex and protects the sensors and other electronics, in addition to providing a pleasing aesthetic appearance.

In one embodiment, the sensors are incorporated in a piezoresistive material layer. The piezoresistive properties of the material allow detection of changes in the materials resistance, for example, when the material is subject to mechanical stress, such as a force applied to the fabric.

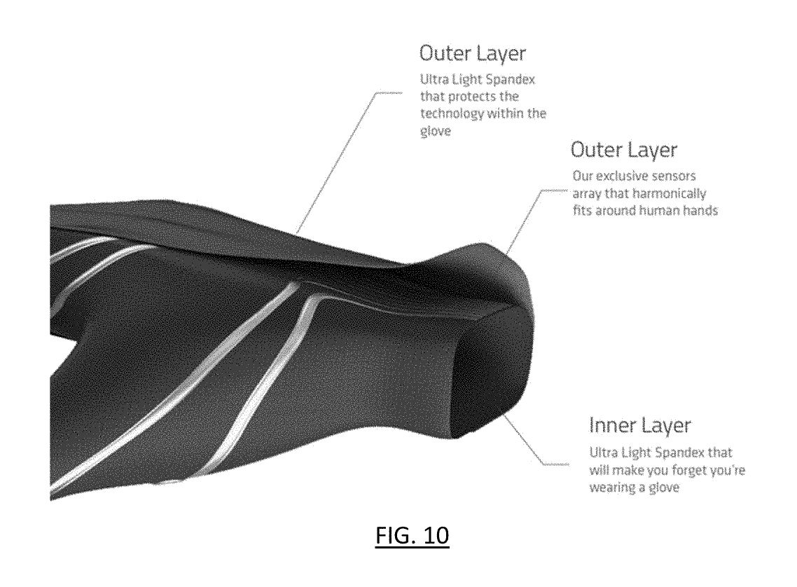

Referring in detail to FIGS. 8-16, several embodiments of the middle layer, or piezoresistive material layer, are depicted. Referring to FIGS. 8-11, the smart glove 200 may comprise a number of sensors and electrodes in communication with a flexible PCB through use of, for example, conductive thread (as shown in FIG. 10). The conductive thread pattern preferably encompasses a number of sensors, including sensors in different regions of the smart glove 200, such as the fingertips and/or palm areas of the smart glove 200. The series of electrodes, preferably connected to the PCB via the conductive fabric, are used to measure the resistance within the piezoresistant areas of the smart glove 200.

Inside the smart glove 200, and preferably in the vicinity of the user's wrist, there is a connector, which transmits data received from the sensors and electrodes to the wearable controller 100 when attached to the smart glove 200. According to certain embodiments, the smart glove 200 and wearable controller 100 communicate via a specified communication protocol, including by way of example but not limitation, i2c, SPI, UART, or other serial communication protocols, or by parallel communication protocol, or by passing analog signals directly between the smart glove 200 and wearable controller 100. In one embodiment, the smart glove 200 is available in at least two sizes, one for both male and female users. In another embodiment, the smart glove 200 is reversible. In another embodiment, the smart glove 200 is flexible to accommodate variations in hand sizes and shapes.

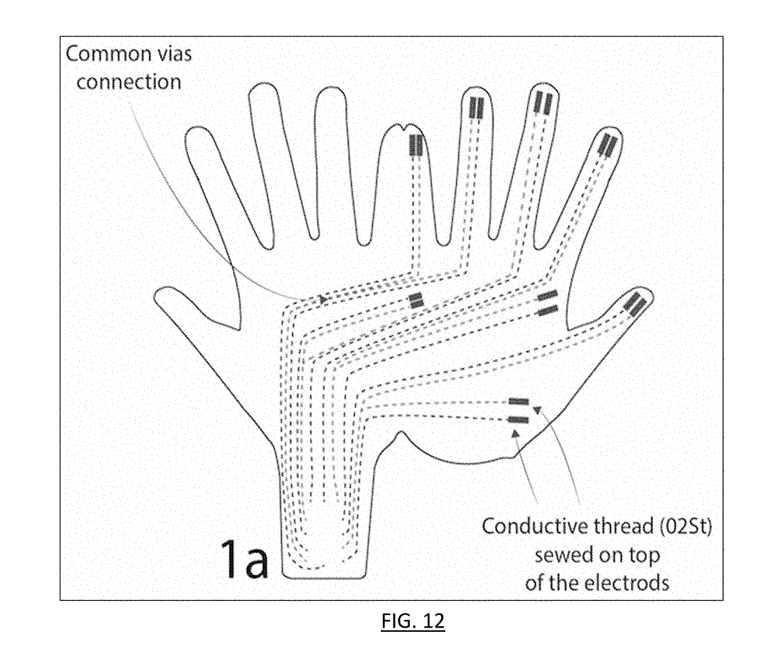

Another embodiment of the smart glove 200 is depicted in FIGS. 12-16. According to varying embodiments, the sensors and electrodes may be sewn in place. In other embodiments, the subcomponents of the smart glove 200 may be glued in place. Conductive spandex or other flexible material may be used to share the common circuit ground with all electrodes and sensors. In certain embodiments, there are greater or fewer than eight sensors associated with the smart glove 200.

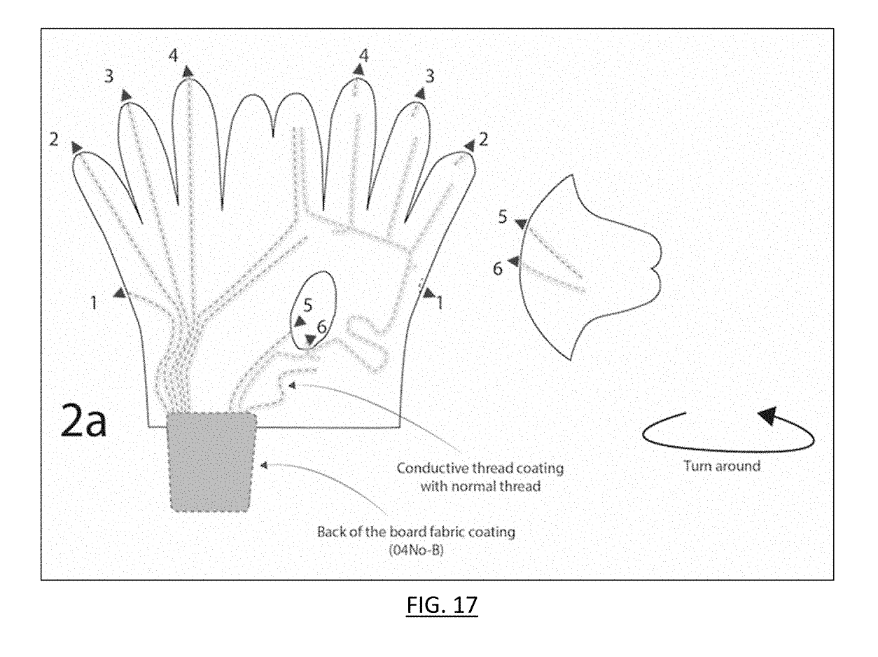

Referring now to FIG. 17, the smart glove and wearable controller are seen in relation to a user's hand and wrist. The smart glove and wearable controller are positioned on the hand and wrist of a user in such a manner to permit great freedom of movement, and thereby impart a number of different commands, controls, gestures, movements, etc. through the smart glove/wearable controller to the mobile device or mobile computer. Multiple combinations exist for associating movements of the user with a precise output. In addition, the user may also associate a first smart glove and wearable controller with one hand, while at the same time associating a second smart glove and wearable controller with a second hand, which may be linked to the same or separate wearable controllers, if desired, without departing from the spirit of the invention described herein. Further details regarding the programming of the smart glove and wearable controller are including below.

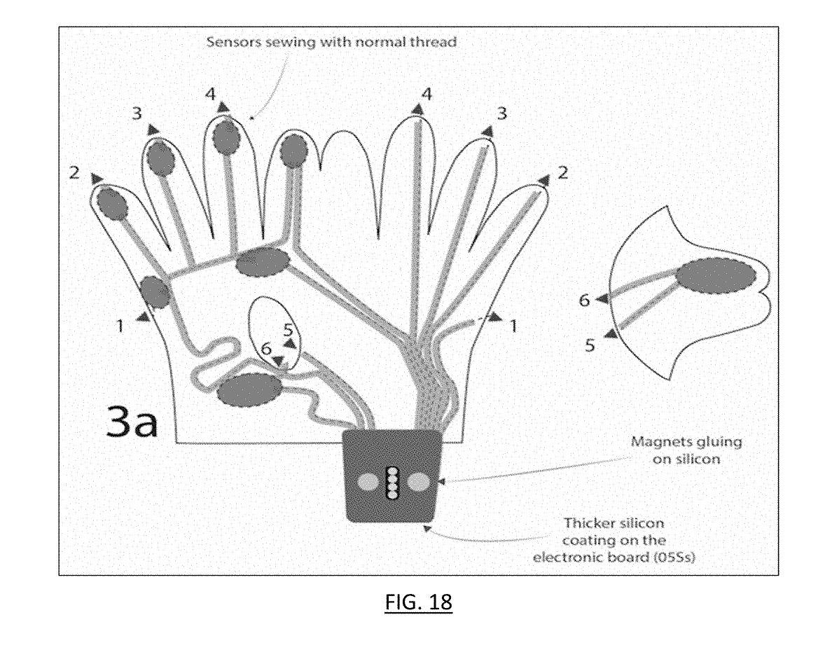

Referring now to FIG. 18, one embodiment of a mobile software application for use with the wearable apparatus and/or wearable controller is shown and described. The mobile device or mobile computer 300 preferably is used in conjunction with a software application to facilitate programming and manipulation of the smart glove and controller described above. The software application may include multiple graphical user interface (“GUI”) displays for visually locating the discrete sensors and electrodes associated with the smart glove and associating the same with different notes, chords, etc. Furthermore, the software application may provide the interface with one or more additional software applications for use in musical recording and/or sound editing, such as, by way of example but not limitation, Ableton, Traktor, Logic Pro X, Resolume, FL Studio, Pace Maker, iMachine, GarageBand, ProTools, Thumbjam, and Animoog.

In one embodiment, the software permits a user to personalize one or more discrete sensors (such as those associated with the smart glove) or gesture control movements (such as those associated with the wearable controller), enable or disable one or more sensors or gesture control movements, impart pressure sensitivity levels for any one or more sensors or gesture control movements, or create custom combinations for one or more sensors or gesture control movements. In certain embodiments, the mobile device or mobile computer may be substituted with a desktop or other style computer.

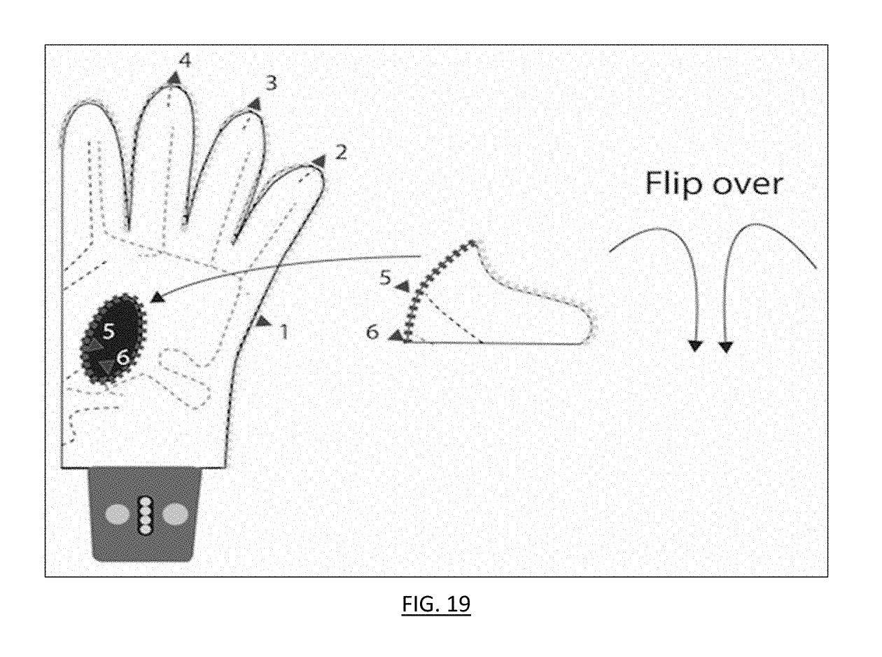

Referring now to FIGS. 19-22, preferred embodiments of the present disclosure further comprise one or more additional software applications for use in creating, composing, revising, remixing, or performing musical compositions created by the user of the smart glove and wearable controller. This software application may also comprise one or more GUI displays for facilitating the user's activity described above, including but not limited to the following: Bluetooth or other communication protocol status; sensor/electrode operation and feedback; Composition title, composer and related information; Battery or power level; Menu options and access to pull down lists; One or more sound bars; One or more switches, buttons, slides or other controls; Sound wave responses to user motions/actions; Sound wave verse direction; Remixing selections; Saving or loading data; Corresponding social media links; and associated artwork. As shown in FIGS. 19-22, these and other display features may be oriented in a manner to permit the user to quickly and easily access and modify tools in the software application, and thereby more efficiently create and modify the musical compositions of the user.

The components described above may all be in communication via one or more mobile devices or mobile computers, which in one embodiment are part of a computing environment. It is expressly understood that, while embodiments described in relation to FIGS. 1-22 depict only a single mobile device or mobile computer, the computing environment may include one or many computing devices. The computers may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These computers may also have any of a variety of applications, including for example, database client and/or server applications, and web browser applications. Alternatively, the computers may be any other electronic device, such as a thin-client computer, Internet-enabled mobile telephone, and/or personal digital assistant, capable of communicating via a network (e.g., the network described below) and/or displaying and navigating web pages or other types of electronic documents. Although exemplary drawing Figures provided herewith may depict only a single computer, any number of user computers may be supported.

Computing environment may further comprise at least one network. The network can be any type of network familiar to those skilled in the art that can support data communications using any of a variety of commercially-available protocols, including without limitation SIP, TCP/IP, SNA, IPX, AppleTalk, and the like. Merely by way of example, the network maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers. One server may be a web server, which may be used to process requests for web pages or other electronic documents from user computers. The web server can be running an operating system including any of those discussed above, as well as any commercially-available server operating systems. The web server can also run a variety of server applications, including SIP servers, HTTP servers, FTP servers, CGI servers, database servers, Java servers, and the like. In some instances, the web server may publish operations available operations as one or more web services.

The computing environment may also include one or more file and or/application servers, which can, in addition to an operating system, include one or more applications accessible by a user running on one or more of the user computers. The server(s) may be one or more general purpose computers capable of executing programs or scripts in response to the user computers. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) may also include database servers, including without limitation those commercially available from Oracle, Microsoft, Sybase™, IBM™ and the like, which can process requests from database clients running on a user computer.

The computing environment may also include a database. The database may reside in a variety of locations. By way of example, database may reside on a storage medium local to (and/or resident in) one or more of the computers. Alternatively, it may be remote from any or all of the computers, and in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10i™ or Microsoft SQL Server 2008, which is adapted to store, update, and retrieve data in response to SQL-formatted commands.

The computer system may comprise various hardware elements, which may be electrically coupled via a bus. The hardware elements may include one or more central processing units (CPUs); one or more input devices (e.g., a mouse, a keyboard, etc.); and one or more output devices (e.g., a display device, a printer, etc.). The computer system may also include one or more storage devices. By way of example, storage device(s) may be disk drives, optical storage devices, solid-state storage devices such as a random access memory (“RAM”) and/or a read-only memory (“ROM”), which can be programmable, flash-updateable and/or the like.

The computer system may additionally include a computer-readable storage media reader; a communications system (e.g., a modem, a network card (wireless or wired), an infra-red mobile device, etc.); and working memory, which may include RAM and ROM devices as described above. In some embodiments, the computer system may also include a processing acceleration unit, which can include a DSP, a special-purpose processor, and/or the like.

The computer-readable storage media reader can further be connected to a computer-readable storage medium, comprehensively representing remote, local, fixed, and/or removable storage devices plus storage media for temporarily and/or more permanently containing computer-readable information. The communications system may permit data to be exchanged with the network and/or any other computer described above with respect to the computer system. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system may also comprise software elements, shown as being currently located within a working memory, including an operating system and/or other code. It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

The network can be any system, connection, or means for communicating between computing devices. Thus, the network can include a local area network, wide area network, cellular network, wireless network, etc. Networks are further defined herein and understood by those skilled in the art. Thus, networks will not be described further.

The server can include any hardware and/or software for executing the actions described herein. The server can include one or more components that may represent separate computer systems or electrical components or may software executed on a computer system. These components include a load balancer, one or more web servers, a database server, and/or a database. The load balancer is operable to receive a communication from the user device and can determine to which web server to send the communication. Thus, the load balancer can manage, based on the usage metrics of the web servers, which web server will receive incoming communications. Once a communication session is assigned to a web server, the load balancer 3410 may not receive further communications. However, the load balancer may be able to redistribute load amongst the web servers if one or more web servers become overloaded.

The one or more web servers are operable to provide web services to the user via the mobile device or mobile computer 300. In embodiments, the web server receives data or requests for data and communicates with the database server to store or retrieve the data. As such, the web server functions as the intermediary to put the data in the database into a usable form for the user devices.

The database server is any hardware and/or software operable to communicate with the database and to manage the data within the database. Database servers, for example, SQL server, are well known in the art and will not be explained further herein. The database can be any storage mechanism, whether hardware and/or software, for storing and retrieving data. The database can be as described further herein.

According to one embodiment, the embodiments described above are well suited for use in composing or editing musical arrangements. In practice, a user is preferably permitted to program notes, sounds, samples, melodies, etc. with each of the sensors or electrodes associated with the smart glove, and may further program the ability to repeat or create custom effects, such as staccato effect, by continued selection of a particular sensor. In this example, the user could create and access a custom effect simply by continuing to depress a particular sensor or electrode associated with that effect by programming through the software application. In yet another example, the user may add distortion effects by programming the effect to correlate to a particular rotation of the wearable controller. In yet another example, the user may program the effect to occur upon movement of the wrist in a particular direction or series of directions. The software application, preferably running on the mobile device or mobile computer, allows the user to store the programmed notes, sounds, samples, melodies, effects, etc. for accessing again at a later time.

In the foregoing description, for the purposes of illustration, components, systems and methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, while the components and subcomponents (and associated computer hardware and software) have been described in the context of creating musical files, it is expressly contemplated that the foregoing invention may be used in healthcare, entertainment, communication, home automation, fitness, education and training, military, gaming and other industries with equivalent efficacy.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figures. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments have been described in detail herein, it is to be understood that the concepts may be otherwise variously embodied and employed, and that the foregoing disclosure is intended to be construed to include such variations, except as limited by the prior art.

1. A system for communicating with at least one electronic device, comprising:
a first wearable apparatus, comprising a plurality of sensors configured to receive tactile inputs from a user's fingertips, thumb, palm, and/or hand;
a second wearable apparatus, comprising:
a controller configured to receive inputs from the first wearable apparatus;
an accelerometer configured to register movements of the second wearable apparatus;
one or more inputs/outputs associated with the controller; and
at least one printed circuit board;
means for communicating between the first wearable apparatus, the second wearable apparatus and at least one electronic device;
wherein the plurality of sensors relay tactile inputs received from a user's fingertips, thumb, palm, and/or hand to the second wearable apparatus, and wherein the second wearable apparatus relays certain of those inputs to the at least one electronic device; and
wherein a user of the system may create, edit, control and interact with digital, virtual, augmented, mixed reality and/or gaming environments by use of the first and second wearable apparatus.

2. The system according to claim 1 wherein the first wearable apparatus is coupled to the second wearable apparatus.

3. The system according to claim 1 wherein the at least one electronic device is a mobile device or computer, wherein the mobile device or computer further comprises at least one application configured to receive inputs from the first and/or second wearable device.

4. The system according to claim 1 wherein the second wearable apparatus comprises a gyroscope in addition to or in lieu of an accelerometer.

5. The system according to claim 1 wherein the second wearable apparatus is configured to detect movement of the user while wearing the second wearable apparatus, and wherein detected movements are relayed to the at least one electronic device.

6. The system according to claim 1 wherein the first wearable apparatus is in the form of a glove.

7. The system according to claim 1 wherein the second wearable apparatus is in the form of a bracelet, watch or wristband.

8. The system according to claim 1 wherein the first and/or second wearable apparatus are configured to relay inputs to more than one electronic device in a near simultaneous manner.

9. The system according to claim 5 wherein the second wearable apparatus further comprises an Inertial Measurement Unit (“IMU”) to detect motion of the user.

10. The system according to claim 6 wherein the first wearable apparatus comprises a plurality of discrete pressure sensors, a plurality of bending sensors, and a plurality of motion sensors.

11. The system according to claim 10 wherein three of the plurality of pressure sensors are located in the palm of the first wearable apparatus, at least one of the plurality of pressure sensors is located in the vicinity of each fingertip of the first wearable apparatus, one of the plurality of bending sensors is located in the palm of the first wearable apparatus and five of the plurality of bending sensores are located on the back of the first wearable apparatus in the vicinty of each finger.

12. The system according to claim 1 wherein the second wearable apparatus further comprises a vibrator, oscillator or equivalent, which is configured to pulse or vibrate against the user's skin when certain conditions are met or certain inputs are received.

13. The system according to claim 1 wherein the second wearable apparatus further comprises a display for providing information to the user.

14. The system according to claim 1 wherein the one or more inputs/outputs associated with the controller include one or more buttons and one or more LEDs.
